(19) United States
(12) Patent Application Publication
(10) Pub. No.: US 2026/0097759 A1
(43) Pub. Date: Apr. 9, 2026

(54) VEHICLE CONTROL DEVICE AND CONTROL METHOD

(71) Applicant: TOYOTA JIDOSHA KABUSHIKI KAISHA, Toyota-shi (JP)

(72) Inventor: Naoki IGUCHI, Toyota-shi (JP)

(73) Assignee: TOYOTA JIDOSHA KABUSHIKI KAISHA, Toyota-shi (JP)

(21) Appl. No.: 19/289,477

(22) Filed: Aug. 4, 2025

(30) Foreign Application Priority Data
Oct. 4, 2024 (JP) 2024-175270

(51) Int. Cl. B60W 30/09; B60W 10/18; B60W 30/095; B60W 30/14; B60W 40/08; B60W 40/09; B60W 50/00; B60W 50/10

(52) U.S. Cl. CPC B60W 30/09; B60W 10/18; B60W 30/0956; B60W 30/146; B60W 40/09; B60W 50/0097; B60W 50/10; B60W 2040/0818; B60W 2540/12; B60W 2540/229; B60W 2554/80

(57) ABSTRACT

A vehicle control device configured to be capable of executing brake assist control of an host vehicle, wherein a first brake operation tendency including a brake response tendency and a brake operation amount inclination as brake operation characteristics of the driver and a second brake operation tendency for determining a deceleration intention of the driver with respect to the target object are acquired, and when it is determined that the driver is a driver having a low capability level for avoiding a collision risk based on the first brake operation tendency and it is determined that the brake operation is performed with a deceleration intention with respect to the target object based on the second brake operation tendency, the operation of the brake assist control is facilitated.

### CROSS-REFERENCE TO RELATED APPLICATION

This application claims priority to Japanese Patent Application No. 2024-175270 filed on Oct. 4, 2024. The disclosure of the above-identified application, including the specification, drawings, and claims, is incorporated by reference herein in its entirety.

### BACKGROUND

### 1. Technical Field

The present disclosure relates to a vehicle control device and control method.

### 2. Description of Related Art

Pre-crash safety (Pre-crash Safety: hereinafter “PCS”) for executing collision damage mitigation control for mitigating collision damage between the host vehicle and an obstacle ahead is known. Examples of the collision damage mitigation control of PCS include alarm control in which a driver is alerted by a speaker or a display, pre-crash brake assist (Pre-crash Brake Assist: hereinafter PBA) control in which a brake operation is assisted when a driver depresses a brake pedal, and pre-crash brake (Pre-crash Brake: hereinafter PB) control in which the vehicle is automatically decelerated even if a driver does not depress a brake pedal. Examples of the PB control include an autonomous emergency brake (Autonomous Emergency Brake: hereinafter AEB) control for forcibly applying a braking force to the vehicle, and light pre-crash brake (Light Pre-crash Brake: hereinafter LPB) control for applying a relatively small braking force to the vehicle in a stage prior to the AEB control. It is desirable that brake interventions in the PBA control, the LPB control, or the like should effectively reduce the risk of a collision by appropriately activating the brake when needed while suppressing unwanted activation.

For example, Japanese Unexamined Patent Application Publication No. 2008-189139 (JP 2008-189139 A) discloses an apparatus in which, when an obstacle that may collide with the host vehicle is detected, the attitude and the line-of-sight direction of the driver are determined, and the priority of automatic collision avoidance control and driver operation control is determined according to the determination result.

### SUMMARY

In the apparatus described in JP 2008-189139 A, the priority is determined based on the attitude and the line-of-sight direction of the driver. However, there is a possibility that a driver having an operation characteristic in which the timing of the brake operation is late or the depression force of the brake pedal is weak cannot perform a sufficient collision avoidance operation, even if the line-of-sight direction of the driver is directed toward an obstacle ahead, for example. In such a case, the collision risk cannot be effectively reduced.

The present disclosure has been made to address the above issue, and has an object to effectively reduce a collision risk while suppressing unnecessary activation of vehicle control related to reduction of a collision risk.

An aspect of the present disclosure provides
a vehicle control device that acquires a relative relationship between a host vehicle and a target object existing in a traveling direction of the host vehicle and that is configured to be able to execute, when it is determined based on the acquired relative relationship that a collision risk between the host vehicle and the target object is equal to or higher than a predetermined level, vehicle control including brake assist control for assisting deceleration based on a brake operation by a driver of the host vehicle as vehicle control related to reduction of the collision risk, the vehicle control device including: a first brake operation tendency acquisition unit that acquires a first brake operation tendency including at least one or both of a brake response tendency and a brake operation amount tendency as a brake operation characteristic of the driver with respect to the target object at a time when the collision risk becomes equal to or higher than the predetermined level; and
a second brake operation tendency acquisition unit that acquires, as a second brake operation tendency, a brake operation tendency for determining a deceleration intention of the driver with respect to the target object at a time when the collision risk becomes equal to or higher than the predetermined level, in which
the vehicle control device facilitates activation of the brake assist control when a specific condition is met as compared with when the specific condition is not met, the specific condition being met when it is determined based on the acquired first brake operation tendency that the driver is a driver having a low capability level for avoiding a collision risk with the target object and when it is determined based on the acquired second brake operation tendency that the brake operation by the driver at a time when the collision risk becomes equal to or higher than the predetermined level is performed with a deceleration intention with respect to the target object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a hardware configuration of a vehicle according to the present embodiment;

FIG. 2 is a schematic diagram illustrating a software configuration of the control device according to the present embodiment;

FIG. 3 is a flowchart for explaining a routine of the learning process of the brake reaction tendency according to the present embodiment;

FIG. 4 is a flowchart for explaining a routine of the learning process of the braking force tendency according to the present embodiment;

FIG. 5 is a flowchart illustrating a routine of the deceleration intention learning process according to the present embodiment;

FIG. 6A is a schematic diagram illustrating an example of a PBA control accelerating process according to the present embodiment;

FIG. 6B is a schematic diagram illustrating an exemplary situation in which the early processing of PBA control according to the present exemplary embodiment is not performed;

FIG. 7A is a schematic diagram illustrating an example of an LPB control accelerating process according to the present embodiment;

FIG. 7B is a schematic diagram illustrating an exemplary case in which an early processing of LPB control is not performed according to the present exemplary embodiment; and

FIG. 8 is a flow chart for explaining the routine of PBA control and LPB control accelerating process according to the present embodiment.

### DETAILED DESCRIPTION OF EMBODIMENTS

Hereinafter, a vehicle control device and a control method according to the present embodiment will be described with reference to the drawings.

### Hardware Configuration

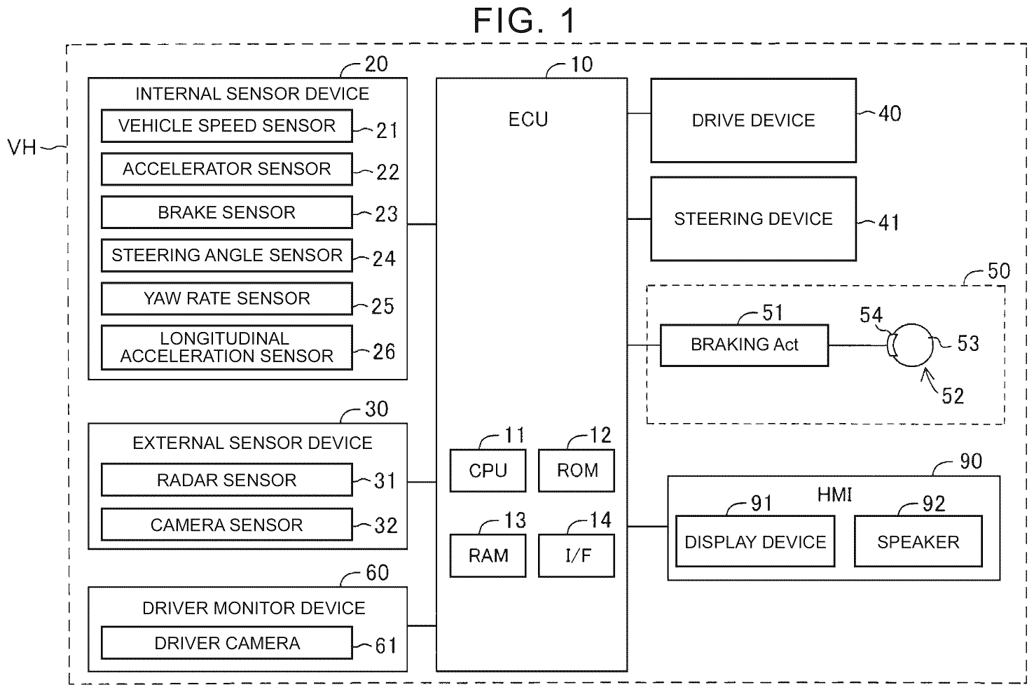

FIG. 1 is a schematic diagram illustrating a hardware configuration of a vehicle VH according to the present embodiment. In the following description, the vehicle VH may be referred to as a host vehicle when it needs to be distinguished from other vehicles or the like.

The vehicle VH has ECU (Electronic Control Unit) 10. ECU 10 includes CPU (Central Processing Unit) 11, ROM (Read Only Memory) 12, RAM (Random Access Memory) 13, and interface device 14. CPU 11 is a processor that executes various programs stored in ROM 12. ROM 12 is a non-volatile memory that stores data and the like required for CPU 11 to execute various programs. RAM 13 provides a working area to be deployed when various programs are executed by CPU 11. The interface device 14 is a communication device for communicating with an external device.

ECU 10 is a central device that provides driving support such as collision damage mitigation control. Driving assistance is a concept including automatic driving. ECU 10 is communicably connected to the internal sensor device 20, the external sensor device 30, the drive device 40, the steering device 41, the brake device 50, the driver monitor device 60, HMI (Human Machine Interface) 90, and the like.

The internal sensor device 20 is a sensor for acquiring the condition of the vehicle VH. The internal sensor device 20 includes a vehicle speed sensor 21, an accelerator sensor 22, a brake sensor 23, a steering angle sensor 24, a yaw rate sensor 25, a longitudinal acceleration sensor 26, and the like.

The vehicle speed sensor 21 detects a traveling speed (vehicle speed V) of the vehicle VH. The accelerator sensor 22 detects an operation amount of an accelerator pedal (not shown) by a driver. The brake sensor 23 detects an operation amount of a brake pedal (not shown) by the driver. The steering angle sensor 24 detects a rotation angle (steering angle) of a steering wheel or a steering shaft (not shown). The yaw rate sensor 25 detects the yaw rate of the vehicle VH. The longitudinal acceleration sensor 26 detects a longitudinal acceleration G which is a longitudinal acceleration of the vehicle VH. The internal sensor device 20 transmits the condition of the vehicle VH detected by the sensors 21 to 26 to ECU 10 at a predetermined cycle.

The external sensor device 30 is a sensor or the like that recognizes target information related to a target in the vicinity of the vehicle VH. The external sensor device 30 includes a radar sensor 31, a camera sensor 32, and the like. Examples of the target information include a surrounding vehicle, a falling object, a white line of a road, and a sign.

The radar sensor 31 detects a target that is present around the vehicle VH. The radar sensor 31 includes a millimeter wave radar and/or a lidar. Millimeter-wave radar radiates radio waves in the millimeter-wave band and receives millimeter waves reflected by targets present in the radiation range. The millimeter wave radar acquires the relative distance, the relative velocity, and the like between the vehicle VH and the target on the basis of the phase difference between the transmitted millimeter wave and the received reflected wave, the attenuation level of the reflected wave, the time from the transmission of the millimeter wave to the reception of the reflected wave, and the like. The lidar sequentially scans the pulsed laser light having a wavelength shorter than the millimeter wave toward a plurality of directions, and receives the reflected light reflected by the target, thereby acquiring the shapes of the targets detected in front of the vehicle VH, the relative distances between the vehicle VH and the targets, the relative velocities, and the like.

The camera sensor 32 captures an image of the surroundings of the vehicle VH and processes the captured image-data to acquire target object information around the vehicle VH. As the camera sensor 32, for example, a digital camera having an image sensor such as a CMOS or a CCD can be used. The target information is information indicating a type of a target detected around the vehicle VH, a relative distance between the vehicle VH and the target, a relative velocity, and the like. The type of the target may be recognized by machine learning such as pattern matching, for example.

The external sensor device 30 repeatedly transmits the acquired target object data to ECU 10 every time a predetermined period elapses. Note that the external sensor device 30 does not necessarily have to include both the radar sensor 31 and the camera sensor 32, and may include, for example, only the radar sensor 31 or only the camera sensor 32.

The drive device 40 generates a driving force to be transmitted to the driving wheels of the vehicle VH. Examples of the drive device 40 include an electric motor and an engine. The vehicle VH may be any of a hybrid electric vehicle, a plug-in hybrid vehicle, a fuel cell electric vehicle, battery electric vehicle, and an engine-driven vehicle. The steering device 41 applies a steering force to the wheels of the vehicle VH.

The brake device 50 is, for example, a disc-type brake device, and applies a braking force to the wheels of the vehicle VH. The brake device 50 includes a brake actuator 51, a brake mechanism 52, and the like. The brake actuator 51 is provided in a hydraulic circuit between a master cylinder (not shown) that pressurizes the hydraulic oil by the pedal force of the brake pedal and the brake mechanism 52. The brake mechanism 52 includes a brake disc 53 fixed to the wheel and a brake caliper 54 fixed to the vehicle body. The brake actuator 51 adjusts the hydraulic pressure to be supplied to the wheel cylinder built in the brake caliper 54 in response to an instruction from ECU 10, and actuates the wheel cylinder by the hydraulic pressure. Accordingly, the brake actuator 51 presses the brake pad against the brake disc 53 to generate a friction braking force. The brake device 50 may be a drum type brake device or the like.

The driver monitor device 60 is a device that acquires the status of the driver of the vehicle VH, and includes, for example, a driver camera 61. The driver camera 61 mainly captures an image of the driver's face, and detects the direction of the driver's face, the line-of-sight direction, and the like from the captured face image. The driver monitor device 60 transmits the state of the driver (hereinafter, referred to as driver state information) acquired based on the detection result of the driver camera 61 to ECU 10 at a predetermined cycle.

HMI 90 is an interface for inputting and outputting data between ECU 10 and drivers, and includes an input device and an output device. Examples of the input device include a touch panel, a switch, and a sound pickup microphone. Examples of the output device include a display device 91 and a speaker 92. The display device 91 is, for example, a center display, a multi-information display, a head-up display, or the like. The speaker 92 is, for example, a speaker of an acoustic system or a navigation system.

### Software Configuration

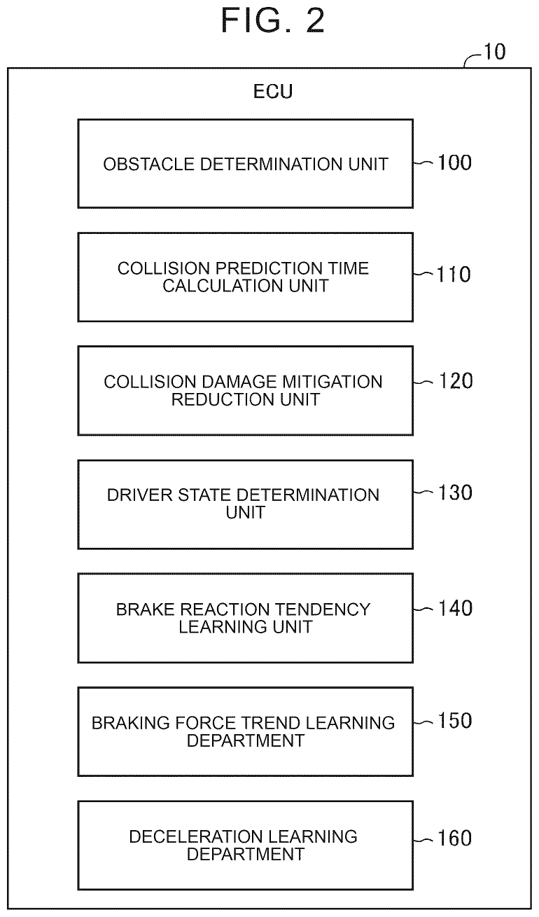

FIG. 2 is a schematic diagram illustrating a software configuration of the control device according to the present embodiment.

As illustrated in FIG. 2, ECU 10 includes an obstacle determination unit 100, a collision prediction time calculation unit 110, a collision damage reduction control unit 120, a driver state determination unit 130, a brake response tendency learning unit 140, a brake depression force tendency learning unit 150, a deceleration intention learning unit 160, and the like as functional elements. These functional elements 100 to 160 are realized by CPU 11 of ECU 10 reading a program stored in ROM 12 into a RAM 13 and executing the program. Note that all or a part of the functional elements 100 to 160 may be provided in another ECU separate from ECU 10 or in an information processing device of a facility (e.g., a control center) capable of communicating with the vehicle VH.

The obstacle determination unit 100 determines whether a front object existing in front of the host vehicle VH is an obstacle that may collide with the host vehicle VH. The obstacle determination unit 100 acquires the coordinate information of the front object based on the target information transmitted from the external sensor device 30. Further, the obstacle determination unit 100 calculates a turning radius of the host vehicle VH based on the detection results of the vehicle speed sensor 21, the steering angle sensor 24, and the yaw rate sensor 25, and calculates a trajectory of the host vehicle VH based on the turning radius. When the forward object is a moving object, the obstacle determination unit 100 calculates the trajectory of the moving object based on the coordinate information of the moving object, and when the trajectory of the moving object and the trajectory of the host vehicle VH intersect each other, determines that the forward object is an obstacle. Further, the obstacle determination unit 100 determines the front object as an obstacle when the front object is a stationary object and when the trajectory of the host vehicle VH intersects the present position of the stationary object.

The obstacle determination unit 100 determines that the front object is an obstacle. Then, the collision prediction time calculation unit 110 calculates a collision prediction time (Time To Collision: TTC) until the host vehicle VH collides with the obstacle based on the distance L from the host vehicle VH to the obstacle and the relative velocity Vr of the host vehicle VH with respect to the obstacle. TTC is an index indicating a possibility that the host vehicle VH collides with an obstacle. The collision-prediction-time calculation unit 110 acquires the distance L from the host vehicle VH to the obstacle and the velocity Vr between the host vehicle VH and the obstacle based on the detection result of the external sensor device 30. The collision-prediction-time calculation unit 110 calculates TTC by dividing the distance L from the host-vehicle VH to the obstacle by the relative-velocity Vr (TTC=L/Vr).

The collision damage reduction control unit 120 executes collision damage mitigation control, which is vehicle control for reducing the risk of collision between the host vehicle VH and an obstacle ahead. Specifically, the collision damage reduction control unit 120 executes alarm control, PBA control, LPB control, and AEB control as respective collision damage mitigation controls. Hereinafter, the details of these controls will be described.

When the obstacle determination unit 100 determines that the forward object is an obstacle and TTC calculated by the collision-prediction-time calculation unit 110 becomes equal to or smaller than a predetermined first threshold T_{V1}, the collision damage reduction control unit 120 executes an alert control for urging the drivers to give attention. The alarm control is executed, for example, by displaying an alert image on the display device 91 or outputting an alarm sound from the speaker 92.

After the alarm control is executed, TTC calculated by the collision-prediction-time calculation unit 110 may be equal to or less than a predetermined second threshold T_{V2} (<T_{V1}) that is smaller than the first threshold T_{V1}. When the driver depresses the brake pedal at a predetermined operating threshold BV or more, the collision damage reduction control unit 120 executes PBA control. PBA control is performed by setting the assist hydraulic pressure of the brake device 50 (master cylinder) to be larger than that in the normal state, thereby improving the responsiveness of the driver to the brake pedal depression. The assist hydraulic pressure may be constant or may be set to increase stepwise with decreasing TTC.

After the alarm control is executed, TTC calculated by the collision-prediction-time calculation unit 110 may be equal to or less than a predetermined third threshold T_{V3} (<T_{V1}) that is smaller than the first threshold T_{V1}. In this case, even if the driver does not depress the brake pedal, the collision-damage reduction control unit 120 executes LPB control for decelerating VH of vehicles. LPB control is performed by activating the brake device 50 to apply a relatively low braking force to the vehicle VH.

After LPB control is executed, TTC calculated by the collision-prediction-time calculation unit 110 may be equal to or smaller than a predetermined fourth threshold T_{V4} (<T_{V3}) that is smaller than the third threshold T_{V3}. In this case, even if the driver does not depress the brake pedal, the collision-damage reduction control unit 120 executes AEB control for rapidly decelerating the vehicle VH. AEB control is performed by activating the brake device 50 to apply a relatively large braking force to the vehicle VH.

However, when PBA control is executed in such a situation that the driver has no intention to decelerate and the driver simply places his/her foot on the brake pedal, there is a problem that the driver is troublesome due to unnecessary operation. On the other hand, PBA control is operated at a normal timing with respect to a driver having an operating property such that the depression timing of the brake pedal is slow or the depression force of the brake pedal is weak. In this case, there is a problem that the starting of PBA control becomes slow, and thus the collision-risk cannot be effectively reduced. Further, when LPB control is operated at a normal timing in an inattentive state in which the driver is not looking forward, there is a problem that the collision risk cannot be sufficiently reduced, for example, in a high-relative-speed state in which the possibility of collision is high. That is, it is desired to effectively suppress unnecessary operation of PBA control and LPB control, and to appropriately operate when required.

In the present embodiment, the above-described problem is solved by learning the braking operation characteristics and the deceleration intention of the driver, determining the inattentiveness state of the driver, and effectively reflecting these conditions on the operation conditions of PBA control and LPB control. Hereinafter, specific functional elements will be described in detail.

The driver state determination unit 130 determines whether or not the direction of the driver's face and the line-of-sight direction are in a forward-looking state that is directed toward the front of the vehicle VH, based on the driver state information transmitted from the driver monitor device 60. For example, the driver state determination unit 130 determines that the driver is in a forward-looking state when the direction of the driver's line of sight or the direction of the face recognized based on the driver state information is directed to a predetermined area including the front of the vehicle VH. On the other hand, the driver state determination unit 130 determines that the driver is not in a forward-looking state, that is, in an inattentive state, when the direction of the driver's line of sight and the direction of the face recognized based on the driver state information are not directed to a predetermined area including the front of the vehicle VH.

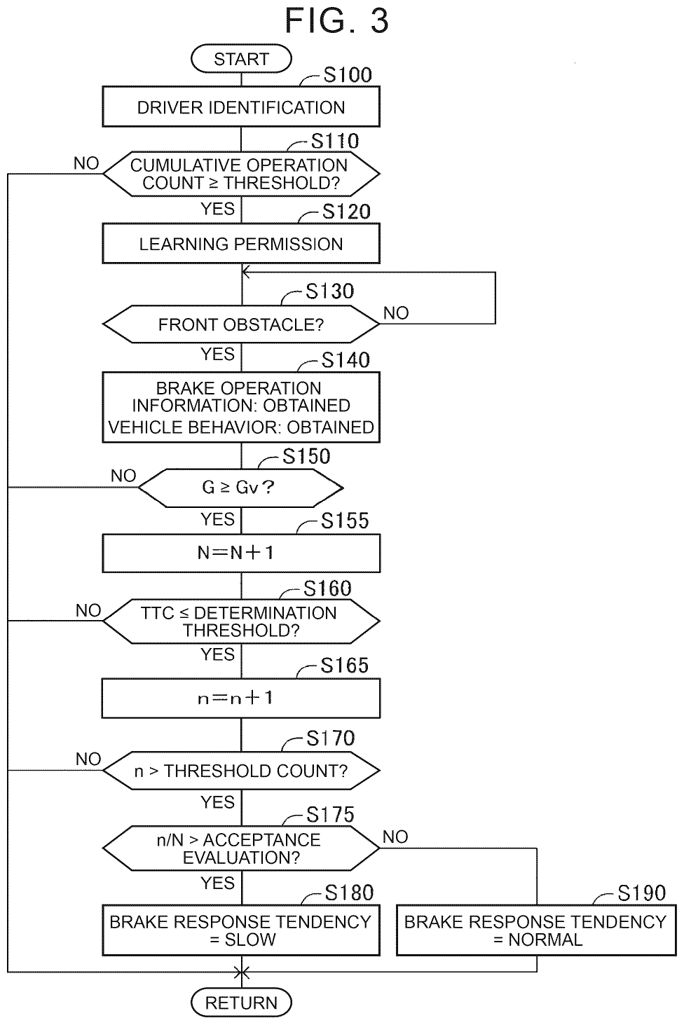

The brake response tendency learning unit 140 is an example of the first brake operation tendency acquisition unit of the present disclosure, and learns the response tendency of the brake operation to the front obstacle of the driver during normal operation. Hereinafter, the flow of the brake reaction tendency learning process will be described based on the flowchart shown in FIG. 3.

In S100, the brake response tendency learning unit 140 specifies driver information (whether or not the driver information is the same driver) based on facial images of the driver transmitted from the driver monitor device 60. The identification of the driver may be determined based on a smartphone or the like possessed by the driver.

Next, in S110, the brake response tendency learning unit 140 determines whether or not the cumulative number of times (hereinafter, referred to as the cumulative number of times of driving) that the specified drivers actually perform driving operations while riding on the vehicle VH is equal to or greater than a predetermined threshold. The cumulative number of operations may be counted, for example, on the basis of on/off of an ignition or a power switch. When the cumulative number of operations is equal to or greater than the predetermined threshold (Yes), the brake response tendency learning unit 140 proceeds to S120 process. On the other hand, when the cumulative number of operations is less than the predetermined threshold (No), the brake response tendency learning unit 140 returns this routine. That is, a driver whose cumulative operation count does not satisfy the condition is regarded as a guest and is excluded from the learning target.

In S120, the brake response tendency learning unit 140 permits the learning of the brake response tendency. Next, in S130, the brake response tendency learning unit 140 determines whether or not an obstacle exists in front of the host vehicle VH based on the determination result of the obstacle determination unit 100. When there is an obstacle (Yes), the brake response tendency learning unit 140 proceeds to S140 process. On the other hand, when there is no obstacle (No), the brake response tendency learning unit 140 repeats S130 process.

In S140, the brake response tendency learning unit 140 acquires the brake operation information from the time when TTC calculated by the collision-prediction-time calculation unit 110 becomes equal to or less than the predetermined designated value until the vehicle VH stops (or the vehicle speed decreases to the predetermined low vehicle speed range), and the vehicle behavior based on the detected result of the internal sensor device 20 or the like. Specifically, the brake response tendency learning unit 140 acquires the stroke amount ST of the brake pedal, the hydraulic pressure P of the master cylinder of the brake device 50, and the longitudinal acceleration G of the vehicle VH.

Next, in S150, the brake response tendency learning unit 140 determines whether or not the longitudinal acceleration G of the vehicle VH acquired by S140 is equal to or greater than a predetermined threshold acceleration Gv. When the longitudinal acceleration G is equal to or greater than the threshold acceleration Gv (Yes), that is, when VH of vehicles is rapidly decelerated, the brake response tendency learning unit 140 proceeds to S155 process. On the other hand, when the longitudinal acceleration G is less than the threshold acceleration Gv (No), the brake response tendency learning unit 140 returns this routine. That is, when the vehicle VH is decelerated at a small longitudinal acceleration G, the vehicle is not urgent, and therefore, the vehicle is excluded from the learning target.

In S155, the brake response tendency learning unit 140 counts up the number of logs of the driver (the number of times the driver rapidly decelerates the vehicle VH: hereinafter, the number of times of the cumulative rapid deceleration N) (N=N+1). Next, in S160, the brake response tendency learning unit 140 determines whether or not TTC calculated by the collision-prediction-time calculation unit 110 when the driver depresses the brake pedal is equal to or less than a predetermined determination threshold. When TTC is equal to or less than the determination threshold (Yes), that is, when the brake depression timing of the driver is delayed, the brake response tendency learning unit 140 proceeds to S165 process. On the other hand, when TTC exceeds the determination threshold (No), that is, when the brake depression timing of the driver is not slow, the brake response tendency learning unit 140 returns.

In S165, the brake response tendency learning unit 140 counts up the brake depression delay counter n of the driver (n=n+1). Next, in S170, the brake response tendency learning unit 140 determines whether or not the brake depression delay counter n exceeds a predetermined number of thresholds. When the brake depression delay counter n exceeds the threshold number of times (Yes), the brake response tendency learning unit 140 proceeds to S175 process. On the other hand, when the brake depression delay counter n is equal to or less than the threshold number of times (No), the brake response tendency learning unit 140 returns this routine. In other words, when a certain number or more of data cannot be collected, the data is excluded from the learning target.

In S175, the brake response tendency learning unit 140 determines whether or not a value obtained by dividing the brake depression delay counter n by the cumulative number of times of rapid deceleration N (=n/N: hereinafter, frequency of slow depression) exceeds a predetermined determination value. When the slow depression frequency n/N exceeds the determination value (Yes), the brake response tendency learning unit 140 proceeds to S180 process. In S180, the brake response tendency learning unit 140 determines that the brake response tendency is slow, and stores the determination result in a storage unit (for example, a ROM 12) in association with the information of the drivers. Thereafter, the brake response tendency learning unit 140 returns the present routine. On the other hand, when the slow depression frequency n/N is less than the determination value (No), the brake response tendency learning unit 140 proceeds to S190 process. In S190, the brake response tendency learning unit 140 determines that the brake response tendency is normal, and stores the determination result in a storage unit (for example, a ROM 12) in association with the information of the drivers. The routine then returns. As described above, by determining based on the slow depression frequency n/N, when the braking depression timing of the driver is improved, the improvement can be effectively reflected. In addition, it is possible to effectively suppress erroneous learning in a case where the brake depression timing of the driver is accidentally delayed due to some factor.

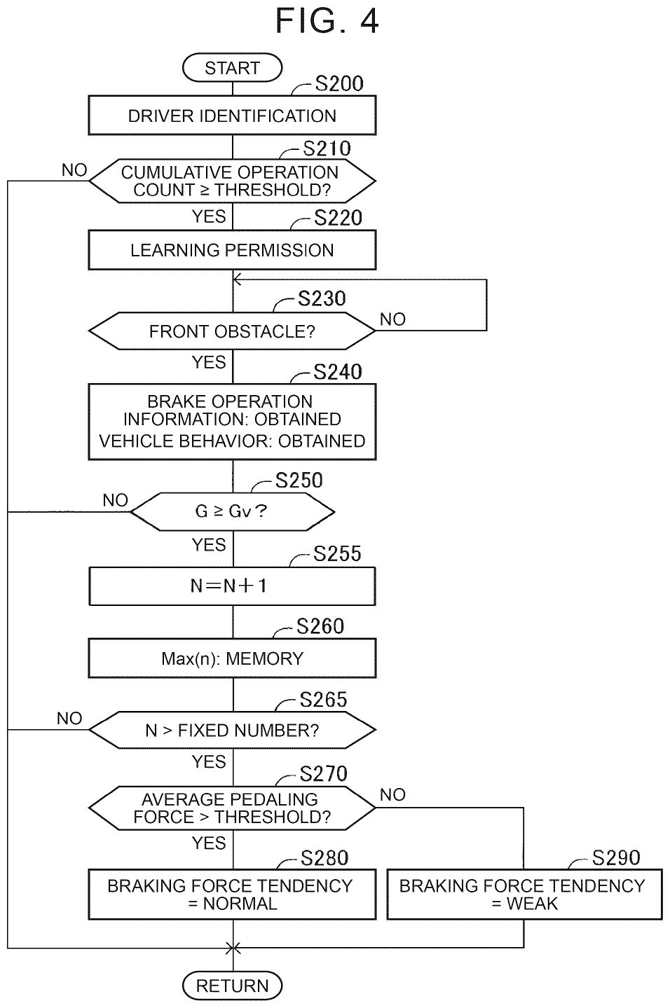

Referring again to FIG. 2, the brake depression force tendency learning unit 150 is an example of the first brake operation tendency acquisition unit of the present disclosure, and learns the pedaling force tendency of the brake pedal with respect to the front obstacle of the driver during normal operation. Hereinafter, the flow of the learning process of the braking force tendency will be described based on the flowchart shown in FIG. 4.

In S200, the brake depression force tendency learning unit 150 specifies driver information (whether or not the driver information is the same driver) based on facial images of the driver transmitted from the driver monitor device 60. Next, in S210, the brake depression force tendency learning unit 150 determines whether or not the cumulative number of driving operations of the specified drivers is equal to or greater than a predetermined threshold. When the cumulative number of operations is equal to or greater than the predetermined threshold (Yes), the brake depression force tendency learning unit 150 proceeds to S220 process. On the other hand, when the cumulative number of operations is less than the predetermined threshold (No), the brake depression force tendency learning unit 150 returns this routine. The processes of S200 and S210 may be omitted by using the process performed by the brake response tendency learning unit 140 (S100, S110 in FIG. 3) in combination.

In S220, the brake depression force tendency learning unit 150 permits the learning of the braking force tendency. Next, in S230, the brake depression force tendency learning unit 150 determines whether or not an obstacle exists in front of the host vehicle VH based on the determination result of the obstacle determination unit 100. When there is an obstacle (Yes), the brake depression force tendency learning unit 150 proceeds to S240 process. On the other hand, when there is no obstacle (No), the brake depression force tendency learning unit 150 repeats S230 process. S230 process may be omitted by using the process performed by the brake response tendency learning unit 140 (S130 in FIG. 3) in combination.

In S240, the brake depression force tendency learning unit 150 acquires the brake operation information from the time when TTC calculated by the collision-prediction-time calculation unit 110 becomes equal to or less than the predetermined designated value until the vehicle VH stops (or the vehicle speed decreases to the predetermined low-vehicle speed range), and the vehicle behavior based on the detection result of the internal sensor device 20 or the like. Specifically, the brake depression force tendency learning unit 150 acquires the stroke amount ST of the brake pedal, the hydraulic pressure P of the master cylinder of the brake device 50, and the longitudinal acceleration G of the vehicle VH. S240 process may be omitted by using the process performed by the brake response tendency learning unit 140 (S140 in FIG. 3) in combination.

Next, in S250, the brake depression force tendency learning unit 150 determines whether or not the longitudinal acceleration G of the vehicle VH acquired by S240 is equal to or greater than a predetermined threshold acceleration Gv. When the longitudinal acceleration G is equal to or greater than the threshold acceleration Gv (Yes), the brake depression force tendency learning unit 150 proceeds to S255 process. On the other hand, when the longitudinal acceleration G is less than the threshold acceleration Gv (No), the brake depression force tendency learning unit 150 returns. S250 process may be omitted by using the process performed by the brake response tendency learning unit 140 (S150 in FIG. 3) in combination.

In S255, the brake depression force tendency learning unit 150 counts up the cumulative number of times of rapid deceleration N (the number of logs of the driver) (N=N+1). S255 process may be omitted by using the process performed by the brake response tendency learning unit 140 (S155 in FIG. 3) in combination. Next, in S260, the brake depression force tendency learning unit 150 stores the stroke amount ST, the hydraulic pressure P, and the maximal value Max(n) of the longitudinal acceleration G acquired by S240 in the storage unit (for example, ROM 12).

In S265, the brake depression force tendency learning unit 150 determines whether or not the cumulative number of times of rapid deceleration N exceeds a predetermined number of times. When the cumulative number of times of rapid deceleration N exceeds the predetermined number of times (Yes), the brake depression force tendency learning unit 150 proceeds to S270 process. On the other hand, when the cumulative number of times of rapid deceleration N is equal to or less than the predetermined number of times (No), the brake depression force tendency learning unit 150 returns this routine. That is, when the data cannot be collected for a certain number or more, the data is excluded from the learning target.

In S270, the brake depression force tendency learning unit 150 determines whether or not a value (=(Max(1) +Max(2)+ . . . +Max(n))/N: hereinafter, the mean pedaling force) obtained by dividing the sum (Max(1) +Max(2)+ . . . +Max(n)) of the maximal value Max(n) of the stroke amount ST, the hydraulic pressure P, and the longitudinal acceleration G stored so far by the cumulative number of times of rapid deceleration N exceeds a predetermined determination threshold. When the mean pedaling force exceeds the determination threshold (Yes), the brake depression force tendency learning unit 150 proceeds to S280 process, determines that the brake pedaling force tendency is normal, and stores the determination result in a storage unit (for example, a ROM 12) in association with the drivers. Thereafter, the brake depression force tendency learning unit 150 returns the present routine. On the other hand, when the mean pedaling force is less than the determination threshold (No), the brake depression force tendency learning unit 150 proceeds to S290 process. In S290, the brake depression force tendency learning unit 150 determines that the brake pedaling force tendency is weak, and stores the determination result in a storage unit (for example, a ROM 12) in association with the drivers. The routine then returns. As described above, by determining based on the average pedaling force, when the pedaling force of the brake pedal of the driver is improved, it is possible to effectively reflect the improvement result. In addition, it is possible to effectively suppress erroneous learning in a case where the brake pedaling force of the driver is accidentally weak due to any factor.

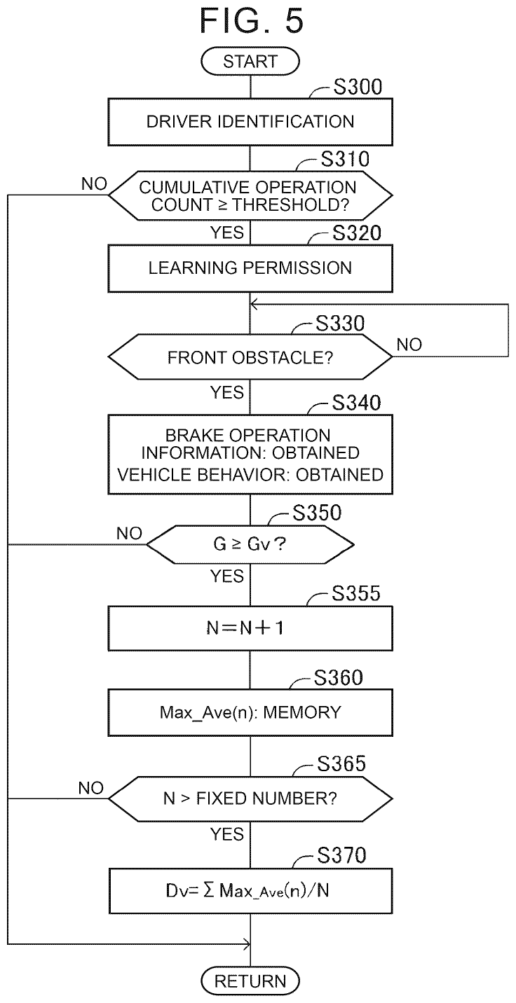

Referring again to FIG. 2, the deceleration intention learning unit 160 is an example of the second brake operation tendency acquisition unit of the present disclosure, and learns the deceleration intention of the driver with respect to the forward obstacle during normal driving. Hereinafter, the flow of the deceleration intention learning process will be described based on the flowchart illustrated in FIG. 5.

In S300, the deceleration intention learning unit 160 specifies driver information (whether or not the driver information is the same driver) based on facial images of the driver transmitted from the driver monitor device 60. Next, in S310, the deceleration intention learning unit 160 determines whether or not the cumulative number of driving operations of the identified drivers is equal to or greater than a predetermined threshold. When the cumulative number of operations is equal to or greater than the predetermined threshold (Yes), the deceleration intention learning unit 160 proceeds to S320 process. On the other hand, when the cumulative operation count is less than the predetermined threshold (No), the deceleration intention learning unit 160 returns this routine. S300 and S310 processes may be omitted by using the process performed by the brake response tendency learning unit 140 (S100, S110 in FIG. 3) in combination.

In S320, the deceleration intention learning unit 160 permits the driver to learn the deceleration intention. Next, in S330, the deceleration intention learning unit 160 determines whether or not an obstacle exists in front of the host vehicle VH based on the determination result of the obstacle determination unit 100. When there is an obstacle (Yes), the deceleration intention learning unit 160 proceeds to S340 process. On the other hand, when there is no obstacle (No), the deceleration intention learning unit 160 repeats S330 process. S330 process may be omitted by using the process performed by the brake response tendency learning unit 140 (S130 in FIG. 3) in combination.

In S340, the deceleration intention-learning unit 160 acquires the braking operation information from when TTC calculated by the collision-prediction-time calculation unit 110 becomes equal to or less than the predetermined designated value until the vehicle VH stops (or the vehicle speed decreases to the predetermined low-vehicle speed range), and the vehicle behavior based on the detected result of the internal sensor device 20 or the like. Specifically, the deceleration intention learning unit 160 acquires the stroke amount ST of the brake pedal, the hydraulic pressure P of the master cylinder of the brake device 50, and the longitudinal acceleration G of the vehicle VH. S340 process may be omitted by using the process performed by the brake response tendency learning unit 140 (S140 in FIG. 3) in combination.

Next, in S350, the deceleration intention learning unit 160 determines whether or not the longitudinal acceleration G of the vehicle VH acquired by S340 is equal to or greater than a predetermined threshold acceleration Gv. When the longitudinal acceleration G is equal to or greater than the threshold acceleration Gv (Yes), the deceleration intention learning unit 160 proceeds to S355 process. On the other hand, when the longitudinal acceleration G is less than the threshold acceleration Gv (No), the deceleration intention learning unit 160 returns this routine. S350 process may be omitted by using the process performed by the brake response tendency learning unit 140 (S150 in FIG. 3) in combination.

In S355, the deceleration intention learning unit 160 counts up the cumulative number of times of rapid deceleration N (the number of logs of drivers) (N 32 N+1). S355 process may be omitted by using the process performed by the brake response tendency learning unit 140 (S155 in FIG. 3) in combination. Next, in S360, the deceleration intention-learning unit 160 stores, in a storage unit (for example, a ROM 12), the maximal value Max-Ave(n) of the moving averages of the stroke amount ST, the hydraulic pressure P, and the longitudinal acceleration G acquired by S340. In this way, by using the moving average, it is possible to eliminate the influence of noise.

In S365, the deceleration intention learning unit 160 determines whether or not the cumulative number of times of rapid deceleration N exceeds a predetermined number of times. When the cumulative number of times of rapid deceleration N exceeds the predetermined number of times (Yes), the deceleration intention learning unit 160 proceeds to S370 process. On the other hand, when the cumulative number of times of rapid deceleration N is equal to or less than the predetermined number of times (No), the deceleration intention learning unit 160 returns this routine. That is, when the data cannot be collected for a certain number or more, the data is excluded from the learning target. S365 process may be omitted by using the process performed by the brake depression force tendency learning unit 150 (S265 in FIG. 4) in combination.

In S370, the deceleration intention learning unit 160 has the total value (Max_{-Ave}(1)+Max_{-Ave}(2)+• • • Max_{-Ave}(n)) of the stored stroke ST, the hydraulic pressure P, and the maximum value Max_{-Ave}(n) of the moving average of the longitudinal acceleration G divided by the cumulative rapid deceleration number N (=(Max_{-Ave}(1)+Max_{-Ave}(2)+ • • • +Max_{-Ave}(n))/N) is calculated, and the calculated value is stored in the storage unit (e.g., ROM 12) in association with the drivers as the deceleration intention threshold Dv. Thereafter, the deceleration intention learning unit 160 returns the present routine.

### Early Treatment of PBA Control

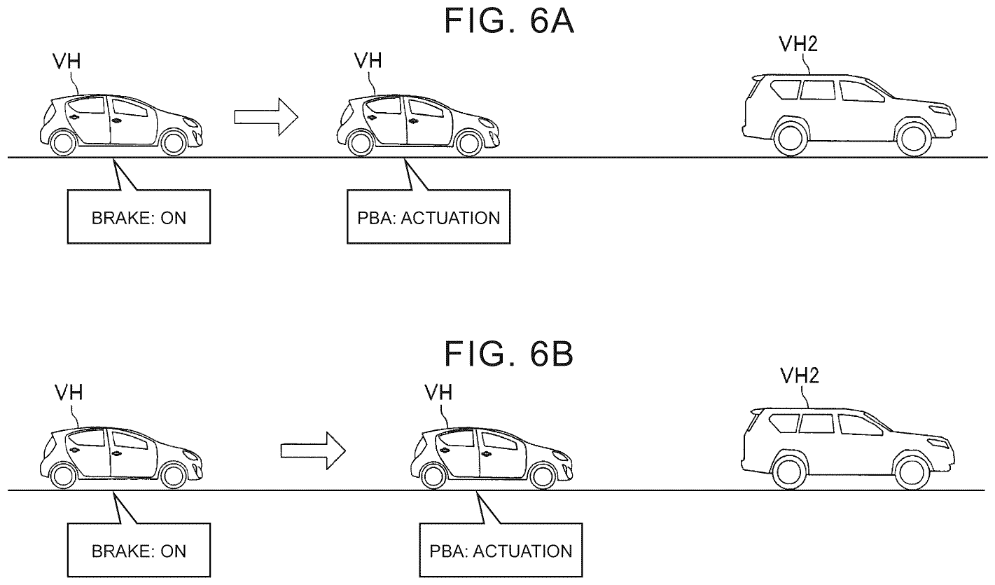

FIGS. 6A and 6B are each a schematic diagram illustrating an example and a PBA control process according to an embodiment of the present disclosure. FIG. 6A shows a case where PBA control is accelerated, and FIG. 6B shows a case where PBA control is not accelerated.

The obstacle determination unit 100 determines the front object (in the illustrated example, VH2 of the preceding vehicles) as an obstacle, and TTC calculated by the collision-prediction-time calculation unit 110 may be equal to or less than a predetermined early activation permission threshold T_{V0}. In this case, the collision damage reduction control unit 120 determines whether or not the current vehicle speed V acquired by the vehicle speed sensor 21 exceeds a predetermined threshold vehicle speed. The early activation permission threshold T_{V0} is not particularly limited, and may be at least larger than the second threshold T_{V2} at which PBA control is activated and the third threshold T_{V3} at which LPB control is activated.

When the current vehicle speed V exceeds the threshold vehicle speed, the collision damage reduction control unit 120 determines whether or not the driver's brake response tendency, the brake pedaling force tendency, and the deceleration intention of the host vehicle VH have been learned. When the brake response tendency, the brake pedaling force tendency, and the deceleration intention have been learned, the collision damage reduction control unit 120 determines whether or not the brake operating property of the driver of the host vehicle VH satisfies the condition for accelerating PBA control. Specifically, the collision damage reduction control unit 120 determines that PBA control is accelerated when the braking behavior of the learned drivers is slow and the braking force tendency is weak.

When determining that PBA control is to be accelerated, the collision-damage-reduction control unit 120 determines whether or not the driver of the host-vehicle VH has a deceleration intention. Specifically, the maximum value Max_{-Ave}(n) of the moving averages of the stroke amount ST, the hydraulic pressure P, and the longitudinal acceleration G in a predetermined time period acquired based on the detection result of the internal sensor device 20 or the like may be equal to or larger than the deceleration intention threshold Dv learned by the deceleration intention learning unit 160. In this situation, the collision damage reduction control unit 120 determines that the driver of the host-vehicle VH has a deceleration intention.

When the collision-damage-reduction control unit 120 determines that PBA control is accelerated and that the driver has an intention to decelerate, PBA control is accelerated. Specifically, the collision damage reduction control unit 120 (1) sets PBA control TTC to be operated to be larger than the second thresholds T_{V2} in the normal state. In addition, (2) the operating threshold BV of the brake pedal is decreased. Thus, the operation timing of PBA control is accelerated (facilitated), and (3) the operation of PBA control is permitted while the driver is depressing the brake pedal.

As described above, for drivers that have a slow braking tendency and have a weak braking force tendency, PBA control can be operated at an early timing to effectively reduce the impact damage. In addition, it is possible to effectively suppress the unnecessary operation by accelerating the operation timing of PBA control only when the driver has a deceleration intention.

### Early Treatment of LPB Control

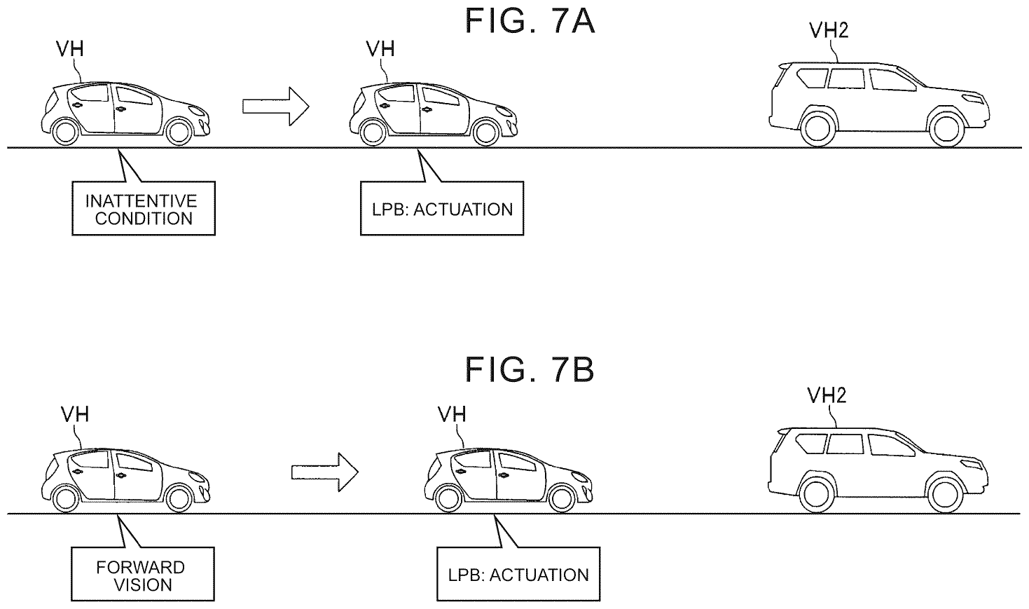

FIGS. 7A and 7B are each a schematic diagram illustrating an example of an LPB control process according to an embodiment of the present disclosure. FIG. 7A shows a case where LPB control is accelerated, and FIG. 7B shows a case where LPB control is not accelerated.

The obstacle determination unit 100 determines the front object (in the illustrated example, VH2 of the preceding vehicles) as an obstacle, and TTC calculated by the collision-prediction-time calculation unit 110 may be equal to or less than the early activation permission threshold T_{V0}. In this case, the collision damage reduction control unit 120 determines whether or not the current vehicle speed V acquired by the vehicle speed sensor 21 exceeds a predetermined threshold vehicle speed. When the current vehicle speed V exceeds the threshold vehicle speed, the collision damage reduction control unit 120 acquires whether or not the driver is in the forward view state based on the determination result of the driver state determination unit 130.

The collision damage reduction control unit 120 determines that LPB control is performed at an early stage when the driver is not in the forward-looking state continuously for a predetermined period of time, that is, when the driver is continuously looking aside. When the condition for accelerating LPB control is satisfied, the collision damage reduction control unit 120 accelerates (facilitates) the operation timing of LPB control by setting TTC for activating LPB control to a value larger than the third threshold T_{V3} for activating LPB control in the normal state. As described above, when the drivers are continuously looking aside, the operation timing of LPB control, which is a substitute for PBA, can be accelerated to effectively reduce the collision damage while suppressing the unnecessary operation.

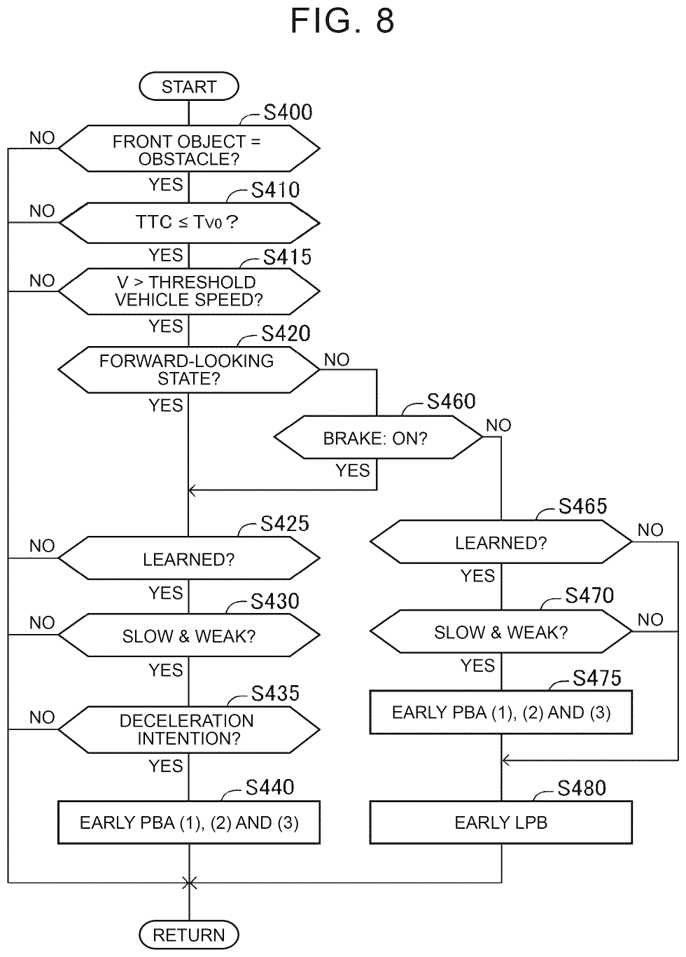

FIG. 8 is a flow chart for explaining a routine of PBA control executed by CPU 11 of ECU 10 and a routine of a process of accelerating LPB control. The routine illustrated in FIG. 8 is started by, for example, traveling of the vehicle VH.

In S400, ECU 10 determines whether the front object of the vehicle VH is an obstacle. If the forward object is an obstacle (Yes), ECU 10 proceeds to S410 process. On the other hand, if the forward object is not an obstacle (No), ECU 10 returns this routine.

In S410, ECU 10 determines whether TTC is less than or equal to the early activation permission threshold T_{V0}. If TTC is less than or equal to the early activation permission threshold T_{V0} (Yes), ECU 10 proceeds to S415 process. On the other hand, if TTC is not less than or equal to the early activation permission threshold T_{V0} (No), i.e., if TTC is greater than the early activation permission threshold T_{V0}, ECU 10 returns this routine.

In S415, ECU 10 determines whether or not the current vehicle speed V of the host vehicle VH exceeds the threshold-value vehicle speed. If the current vehicle speed V of the host vehicle VH exceeds the threshold vehicle speed (Yes), ECU 10 proceeds to S420 process. On the other hand, when the current vehicle speed V of the host vehicle VH does not exceed the threshold vehicle speed (No), since the collision risk can be reduced by the subsequent AEB control at the normal assist timing, ECU 10 returns this routine.

In S420, ECU 10 determines whether the drivers are in a forward-looking condition. If the drivers are in forward view (Yes), ECU 10 proceeds to S425 process. On the other hand, when the driver is not in the forward-looking state (No), that is, when the driver is looking aside, ECU 10 proceeds to S460 process.

In S425, ECU 10 determines whether or not the driver's braking response tendency, braking force tendency, and deceleration intention have been learned. If the driver's braking response tendency, braking force tendency, and deceleration intention have been learned (Yes), ECU 10 proceeds to S430 process. On the other hand, when the braking response tendency, the braking force tendency, and the deceleration intention of the driver have not been learned (No), ECU 10 returns this routine without executing the accelerating process in order to prevent unnecessary operation.

In S430, ECU 10 determines whether or not PBA control is to be accelerated. Specifically, ECU 10 determines that PBA control is accelerated when the braking behavior of the learned drivers is slow and the braking force tendency is weak. When PBA control is accelerated (Yes), ECU 10 proceeds to S435 process. On the other hand, when PBA control is not accelerated (No), the driver has a good braking response and also has a braking force, which increases the possibility that the driver itself can avoid a collision risk. In this situation, ECU 10 returns the routine without executing the accelerating process in order to suppress unnecessary operation.

In S435, ECU 10 determines whether the drivers of the vehicle VH have a deceleration intention. If the driver has a deceleration intention (Yes), ECU 10 proceeds to S440 process. On the other hand, if the driver has no intention to decelerate (No), ECU 10 returns this routine without executing the accelerating process in order to prioritize the driver's intent.

In S440, ECU 10 (1) makes PBA control TTC greater than the second thresholds T_{V2} which activate the PBA control during normal times. In addition, (2) the operating threshold B_{V} of the brake pedal is decreased. As a result, PBA control is activated at an early stage, and (3) the operation of PBA control is permitted while the driver is depressing the brake pedal. ECU 10 then returns the routine.

From the above-described S420, when S460 process is performed, ECU 10 determines whether or not the driver is depressing the brake pedal based on the detection result of the brake sensor 23. If the driver is depressing the brake pedal (Yes), ECU 10 proceeds to S425 process described above. On the other hand, if the driver is not depressing the brake pedal (No), ECU 10 proceeds to S465 process.

In S465, ECU 10 determines whether or not the driver's braking response tendency, braking force tendency, and deceleration intention have been learned. If the driver's braking response tendency, braking force tendency, and deceleration intention have been learned (Yes), ECU 10 proceeds to S470 process. On the other hand, when the braking response tendency, the braking force tendency, and the deceleration intention of the driver have not been learned (No), ECU 10 proceeds to S480 process described later.

In S470, ECU 10 determines whether or not the braking property of the learned drivers satisfies the premature condition of PBA control in which the braking tendency is slow and the braking force tendency is weak. When PBA control is accelerated (Yes), ECU 10 proceeds to S475 process. On the other hand, if PBA control is not accelerated (No), ECU 10 proceeds to S480 process described later.

In S475, ECU 10 (1) makes TTC that activates PBA control larger than the second threshold T_{V2} that activates PBA control at normal time, and (2) reduces the operating threshold B_{V} of the brake pedal. As a result, PBA control is activated at an early stage, and (3) the operation of PBA control is permitted while the driver is depressing the brake pedal. Thus, PBA can be easily operated when the brake pedal is depressed by returning to the front view from the inattentive state, and the driver with a low braking response and a low braking force can effectively reduce the risk of a crash.

In S480, ECU 10 accelerates the activation timing of LPB control by making TTC that activates LPB control larger than the third threshold T_{V3} that activates LPB control at normal time. ECU 10 then returns the routine.

Although the vehicle control device and the vehicle control method according to the present embodiment have been described above, the present disclosure is not limited to the above-described embodiment, and various modifications can be made without departing from the object of the present disclosure. For example, in the above-described embodiment, PBA control is accelerated in a case where the braking response tendency of the driver is slow and the braking force tendency is weak.

What is claimed is:

1. A vehicle control device that acquires a relative relationship between a host vehicle and a target object existing in a traveling direction of the host vehicle and that is configured to be able to execute, when it is determined based on the acquired relative relationship that a collision risk between the host vehicle and the target object is equal to or higher than a predetermined level, vehicle control including brake assist control for assisting deceleration based on a brake operation by a driver of the host vehicle as vehicle control related to reduction of the collision risk, wherein:
the vehicle control device comprises a first brake operation tendency acquisition unit and a second brake operation tendency acquisition unit, the first brake operation tendency acquisition unit acquiring a first brake operation tendency including at least one or both of a brake response tendency and a brake operation amount tendency as a brake operation characteristic of the driver with respect to the target object at a time when the collision risk becomes equal to or higher than the predetermined level, and the second brake operation tendency acquisition unit acquiring, as a second brake operation tendency, a brake operation tendency for determining a deceleration intention of the driver with respect to the target object at a time when the collision risk becomes equal to or higher than the predetermined level; and
the vehicle control device facilitates activation of the brake assist control when a specific condition is met as compared with when the specific condition is not met, the specific condition being met when it is determined based on the acquired first brake operation tendency that the driver is a driver having a low capability level for avoiding a collision risk with the target object and when it is determined based on the acquired second brake operation tendency that the brake operation by the driver at a time when the collision risk becomes equal to or higher than the predetermined level is performed with a deceleration intention with respect to the target object.

2. The vehicle control device according to claim 1, wherein:
the vehicle control device is configured to be able to further execute, in addition to the brake assist control, automatic brake control for applying a braking force to the host vehicle by activating a brake device of the host vehicle, even if the driver does not perform a brake operation, when it is determined that the collision risk is equal to or higher than the predetermined level as the vehicle control related to the reduction of the collision risk;
the vehicle control device further comprises a determination unit that determines whether the driver is in an inattentive state in which the driver is looking in a direction different from a direction of the target object; and
the vehicle control device facilitates the activation of the automatic brake control when the determination unit determines that the driver is in the inattentive state as compared with when the determination unit does not determine that the driver is in the inattentive state.

3. The vehicle control device according to claim 1, wherein the first brake operation tendency acquisition unit calculates a collision prediction time obtained by dividing a distance from the host vehicle to the target object at a time when the driver depresses a brake pedal by a relative speed when the collision risk becomes equal to or higher than the predetermined level, counts a number of times that the calculated collision prediction time is equal to or less than a predetermined threshold as a number of times of delay, and determines whether the brake response tendency of the driver is late based on the counted number of times of delay.

4. The vehicle control device according to claim 1, wherein the first brake operation tendency acquisition unit acquires a brake operation amount of the driver during a period since the collision risk becomes equal to or higher than the predetermined level until the host vehicle stops or decelerates to a predetermined low vehicle speed range, and determines whether the brake operation amount tendency of the driver is weak based on a maximum value of the acquired brake operation amount.

5. A vehicle control method to acquire a relative relationship between a host vehicle and a target object existing in a traveling direction of the host vehicle, and execute, when it is determined based on the acquired relative relationship that a collision risk between the host vehicle and the target object is equal to or higher than a predetermined level, vehicle control including brake assist control for assisting deceleration based on a brake operation by a driver of the host vehicle as vehicle control related to reduction of the collision risk, the vehicle control method comprising:
acquiring a first brake operation tendency including at least one or both of a brake response tendency and a brake operation amount tendency as a brake operation characteristic of the driver with respect to the target object at a time when the collision risk becomes equal to or higher than the predetermined level;
acquiring, as a second brake operation tendency, a brake operation tendency for determining a deceleration intention of the driver with respect to the target object at a time when the collision risk becomes equal to or higher than the predetermined level; and
facilitating activation of the brake assist control when a specific condition is met as compared with when the specific condition is not met, the specific condition being met when it is determined based on the acquired first brake operation tendency that the driver is a driver having a low capability level for avoiding a collision risk with the target object and when it is determined based on the acquired second brake operation tendency that the brake operation by the driver at a time when the collision risk becomes equal to or higher than the predetermined level is performed with a deceleration intention with respect to the target object.
